(19) United States
(12) Patent Application Publication
(10) Pub. No.: US 2015/0107305 A1
(43) Pub. Date: Apr. 23, 2015

(54) GLASS MOLDING METHOD AND GLASS MOLDING DEVICE USED IN THE METHOD

(71) Applicant: WEIS LIMITED, Kwun Tong (HK)

(72) Inventor: KANG WEI, HongKong (CN)

(73) Assignee: WEIS LIMITED, Kwun Tong (HK)

(21) Appl. No.: 14/138,102

(22) Filed: Dec. 22, 2013

(30) Foreign Application Priority Data
Oct. 22, 2013 (TW) 102138083

(51) Int. Cl. C03B 23/03; C03B 25/00; C03B 23/00; C03B 35/14

(52) U.S. Cl. CPC C03B 23/0307; C03B 23/0302; C03B 35/14; C03B 25/00; C03B 23/0086; C03B 2225/00
USPC 65/104; 65/102; 65/274; 65/268; 65/162

(57) ABSTRACT

A glass molding method for molding a glass preform to a glass product via an assembly mold includes the following steps. The glass preform is preheated to a glass molding temperature. The assembly mold is heated to a predetermined mold temperature lower than the glass molding temperature and maintained at the mold temperature. The preheated glass preform is transferred to the assembly mold. The assembly mold is closed together for molding the glass preform to the glass product. The glass product and the assembly mold are gradually cooled to an open temperature. Then the assembly mold is opened to take the glass product out of the assembly mold.

### 1. TECHNICAL FIELD

The disclosure generally relates to molding technologies, and particularly, to a glass molding method and a glass molding device used in the glass molding method.

### 2. DESCRIPTION OF RELATED ART

Generally, a glass preform is heated and cooled together with a mold during a glass molding process. Therefore the mold is occupied during the whole glass molding process, and is not available for molding a next glass preform. This means the efficiency of use of the mold is low. In addition, the glass preform is liable to stick to a molding surface of the mold if the mold contacts the glass preform at high temperature for a long time. This adversely affects the surface quality of the glass product being molded. The high operating temperature of the mold also means that the material of the mold must be of superior quality and very durable. Thus manufacturing the mold is expensive.

Therefore, it is desirable to provide means which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of a first embodiment of a glass molding method.

FIG. 2 is a flowchart of a second embodiment of a glass molding method.

FIG. 3 is a flowchart of a third embodiment of a glass molding method.

FIG. 4 is a flowchart of a fourth embodiment of a glass molding method.

FIG. 5 is a schematic diagram of a glass molding device used to execute the glass molding method of FIG. 1.

FIG. 6 is a schematic diagram of a glass molding device used to execute the glass molding method of FIG. 2.

FIG. 7 is a schematic diagram of a glass molding device used to execute the glass molding methods of FIG. 3 and FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

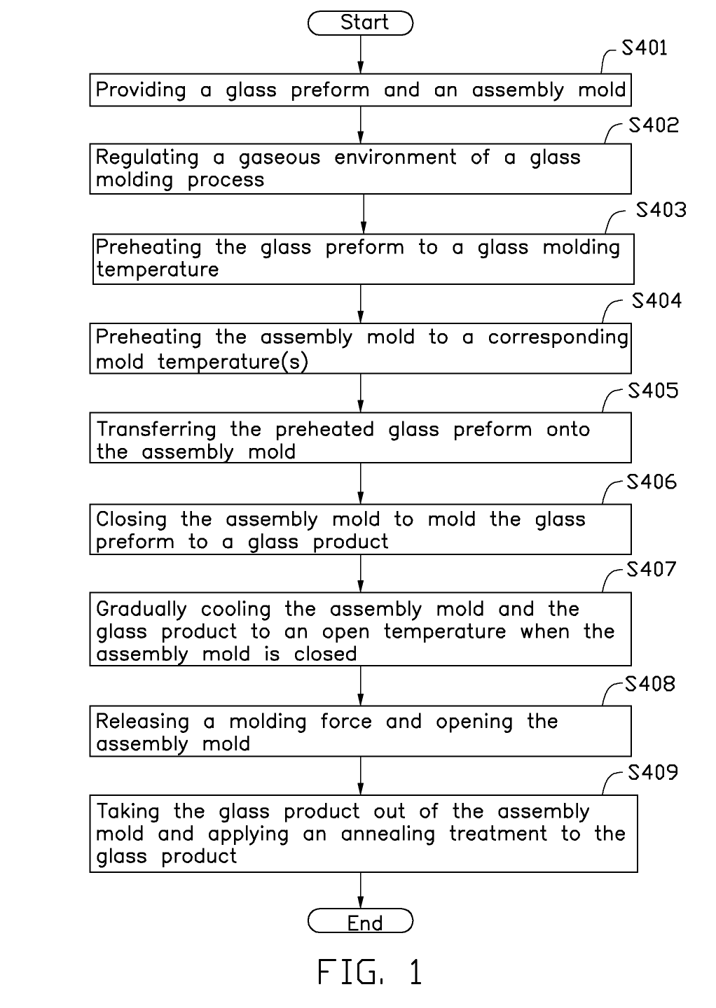

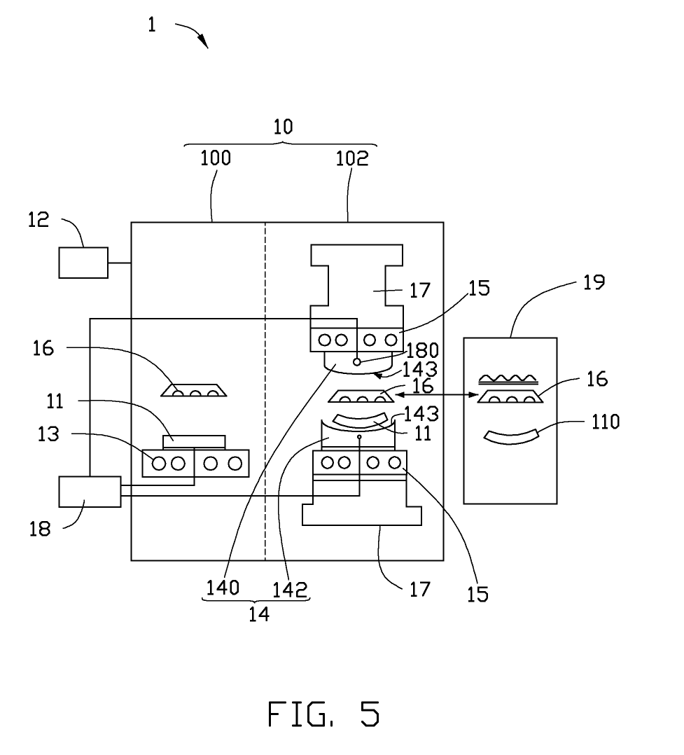

FIG. 1 is a flowchart of a first embodiment of a glass molding method, and FIG. 5 shows a corresponding glass molding device 1. Depending on the embodiment, additional steps may be added, others deleted, and the ordering of the steps may be changed. The glass molding method includes the following steps:

In step S401, a glass preform 11 and an assembly mold 14 are provided. The assembly mold 14 includes at least two sub-molds 140 and 142. In this embodiment, there is an upper sub-mold 140 and a lower sub-mold 142. Each of the sub-molds 140 and 142 includes at least one molding surface 143. When the sub-molds 140 and 142 close together, the molding surfaces 143 of the sub-molds 140 and 142 cooperatively define an enclosed forming space in accordance with a shape of a glass product 110.

In step S402, a gaseous environment of a glass molding process is regulated. The gaseous environment may be an atmospheric environment, an inert gas environment with a predetermined gas pressure (such as a nitrogen, helium, and/or neon inert gas environment), or a vacuum environment. The glass molding process is executed in a molding chamber 10. The gaseous environment inside the molding chamber 10 is regulated by a gas regulating apparatus 12.

In step S403, the glass preform 11 is heated to a glass molding temperature Tₚᵣₑₛₛ at which the glass preform 11 is molded. The glass molding temperature Tₚᵣₑₛₛ is higher than a glass transition temperature T_{g} of the glass preform 11. For example, the glass molding temperature Tₚᵣₑₛₛ of a soda-lime glass preform 11 is in a range of from about 600 degrees Celsius to about 800 degrees Celsius. In this embodiment, the glass molding temperature Tₚᵣₑₛₛ of the glass preform 11 is 730 degrees Celsius.

In step S404, the sub-molds 140 and 142 are preheated to mold temperatures T_{mold1} and T_{mold2}, respectively, and maintained at the mold temperatures T_{mold1} and T_{mold2}. The mold temperatures T_{mold1} and T_{mold2} of the sub-molds 140 and 142 may be different from each other or the same. Each of the mold temperatures T_{mold1} and T_{mold2} of the sub-molds 140 and 142 is lower than the glass molding temperature Tₚᵣₑₛₛ of the glass preform 11. For example, when the glass preform 11 is soda-lime glass, each of the mold temperatures T_{mold1} and T_{mold2} is in a range of from about 400 degrees Celsius to about 600 degrees Celsius. In this embodiment, the mold temperatures T_{mold1} and T_{mold2} are the same, and are both 400 degrees Celsius.

In step S405, the preheated glass preform 11 is transferred onto the molding surface 143 of one of the sub-molds 140 or 142. In this embodiment, the glass preform 11 is put on the molding surface 143 of the lower sub-mold 142.

In step S406, the sub-molds 140 and 142 are closed together to form the glass preform 11 into the glass product 110 with a predetermined shape. When the sub-molds 140 and 142 are closed together, a molding force applied on the glass preform 11 is in a range of from about 0.1 million pascal to about 5 million pascal. In this embodiment, the molding force is 1 million pascal.

In step S407, the closed assembly mold 14 and the glass product 110 formed in the closed assembly mold 14 are cooled to a predetermined open temperature Tₒₚₑₙ. The open temperature Tₒₚₑₙ may be slightly higher than an upper limit of an annealing range of the glass preform 11, or within the annealing range, or slightly lower than a lower limit of the annealing range. The annealing range is a temperature range defined between an annealing point of the glass preform 11 and a strain point of the glass preform 11. The choice of the open temperature Tₒₚₑₙ depends on a balance between a forming precision of the glass product 110 and a short cycle time. For example, to cool the glass product 110 to a lower open temperature Tₒₚₑₙ achieves a better forming precision of the glass product 110; however, the cooling process takes a longer time, and it also lengthens the time of the next preheating process. In this embodiment, the open temperature Tₒₚₑₙ is 400 degrees Celsius when the glass preform 11 is soda-lime glass.

In step S408, the molding force is released and the sub-molds 140 and 142 are separated when the assembly mold 14 and the glass product 110 are cooled to the open temperature Tₒₚₑₙ.

In step S409, the glass product 110 is taken out of the assembly mold 14. Then an annealing treatment is applied to the glass product 110 to relieve any internal stress remaining in the glass product 110.

It is understood that the ordering of step S403 and step S404 may be reversed if desired; and that steps S403 and S404 may be executed at the same time if desired.

It is understood that step S402 and the annealing treatment of step S409 are optional. That is, the glass forming method may be completed without step S402 and/or the annealing treatment of step S409.

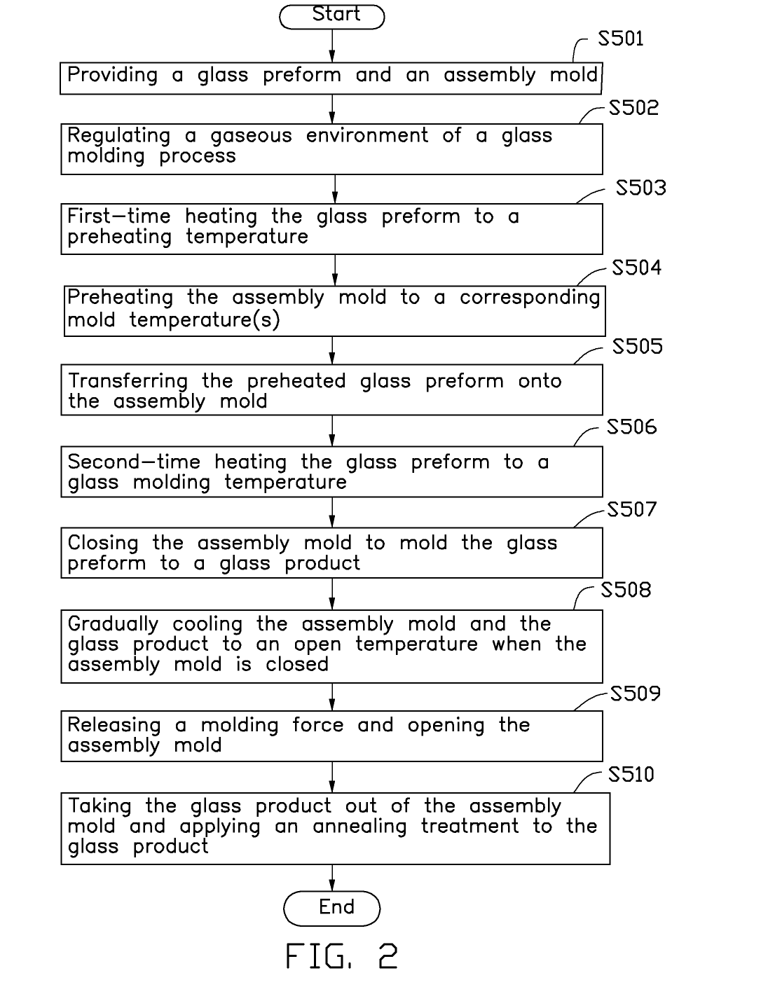

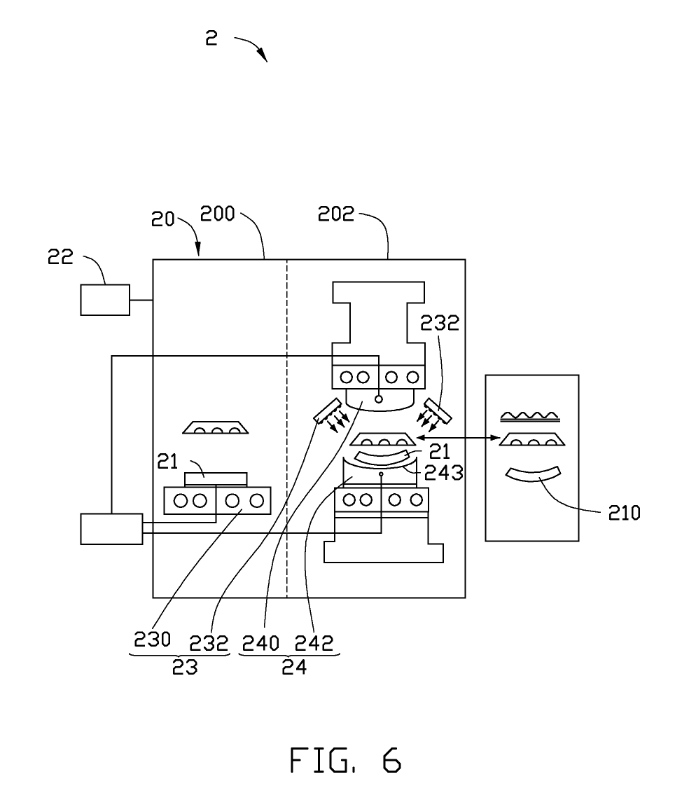

FIG. 2 is a flowchart of a second embodiment of a glass molding method, and FIG. 6 shows a corresponding glass molding device 2. Depending on the embodiment, additional steps may be added, others deleted, and the ordering of the steps may be changed. The glass molding method includes the following steps:

In step S501, a glass preform 21 and an assembly mold 24 are provided. The assembly mold 24 includes at least two sub-molds 240 and 242. In this embodiment, there is an upper sub-mold 240 and a lower sub-mold 242. Each of the sub-molds 240 and 242 includes at least one molding surface 243. When the sub-molds 240 and 242 are closed together, the molding surfaces 243 of the sub-molds 240 and 242 cooperatively define an enclosed forming space in accordance with a shape of a glass product 210.

In step S502, a gaseous environment of a glass molding process is regulated. The gaseous environment may be an atmospheric environment, an inert gas environment with a predetermined gas pressure (such as a nitrogen, helium, and/or neon inert gas environment), or a vacuum environment. The glass molding process is executed in a molding chamber 20. The gaseous environment inside the molding chamber 20 is regulated by a gas regulating apparatus 22.

In step S503, the glass preform 21 is heated a first time, to a preheating temperature T_{glass}. The preheating temperature T_{glass} is between a glass molding temperature Tₚᵣₑₛₛ of the glass preform 21 and a higher one of predetermined mold temperatures T_{mold1} and T_{mold2}. The choice of the preheating temperature T_{glass} also depends on a transferring method of the glass preform 21, in order to accomplish a better step-by-step heating efficiency without too much risk of deformation of the glass preform 21 when transferring the glass preform 21. For example, the preheating temperature T_{glass} should not be too high when the glass preform 21 is transferred by a clamp. If the material of the glass preform 21 is soda-lime glass, the preheating temperature T_{glass} is in a range of from about 550 degrees Celsius to about 650 degrees Celsius. In this embodiment, the preheating temperature T_{glass} is 600 degrees Celsius.

In step S504, the sub-molds 240 and 242 are preheated to mold temperatures T_{mold1} and T_{mold2}, respectively, and maintained at the mold temperatures T_{mold1} and T_{mold2}. The mold temperatures T_{mold1} and T_{mold2} of the sub-molds 240 and 242 may be different from each other or the same. Each of the mold temperatures T_{mold1} and T_{mold2} of the sub-molds 240 and 242 is lower than the glass molding temperature Tₚᵣₑₛₛ of the glass preform 11. For example, when the glass preform 11 is soda-lime glass, each of the mold temperatures T_{mold1} and T_{mold2} is in a range of from about 400 degrees Celsius to about 600 degrees Celsius. In this embodiment, the mold temperatures T_{mold1} and T_{mold2} are the same, and are both 400 degrees Celsius.

In step S505, the first-time heated glass preform 21 is transferred to the molding surface 243 of one of the sub-molds 240 or 242. In this embodiment, the glass preform 21 is put on the molding surface 243 of the lower sub-mold 242.

In step S506, the first-time heated glass preform 21 on the sub-mold 242 is heated a second time to the glass molding temperature Tₚᵣₑₛₛ. The glass molding temperature Tₚᵣₑₛₛ is higher than a glass transition temperature T_{g} of the glass preform 21. For example, the glass molding temperature Tₚᵣₑₛₛ of a soda-lime glass preform 21 is in a range of from about 600 degrees Celsius to about 800 degrees Celsius. In this embodiment, the glass molding temperature Tₚᵣₑₛₛ of the glass preform 21 is 730 degrees Celsius.

In step S507, the sub-molds 240 and 242 are closed together, to form the glass preform 21 into the glass product 210 with a predetermined shape. When the sub-molds 240 and 242 are closed together, a molding force applied on the glass preform 21 is in a range of from about 0.1 million pascal to about 5 million pascal. In this embodiment, the molding force is 1 million pascal.

In step S508, the closed assembly mold 24 and the glass product 210 formed in the closed assembly mold 24 are cooled to a predetermined open temperature Tₒₚₑₙ. The open temperature Tₒₚₑₙ may be slightly higher than an upper limit of an annealing range of the glass preform 21, or within the annealing range, or slightly lower than a lower limit of the annealing range. The annealing range is a temperature range defined between an annealing point of the glass preform 21 and a strain point of the glass preform 21. The choice of the open temperature Tₒₚₑₙ depends on a balance between a forming precision of the glass product 210 and a short cycle time. For example, to cool the glass product 210 to a lower open temperature Tₒₚₑₙ achieves a better forming precision of the glass product 210; however, the cooling process takes a longer time, and it also lengthens the time of the next preheating process. In this embodiment, the open temperature Tₒₚₑₙ is 400 degrees Celsius when the glass preform 21 is soda-lime glass.

In step S509, the molding force is released and the sub-molds 240 and 242 are separated when the assembly mold 24 and the glass product 210 are cooled to the open temperature Tₒₚₑₙ.

In step S510, the glass product 210 is taken out of the assembly mold 24. Then an annealing treatment is applied to the glass product 210 to relieve any internal stress remaining in the glass product 210.

It is understood that the ordering of step S503 and step S504 may be reversed if desired; and that steps S503 and S504 may be executed at the same time if desired.

It is understood that step S502 and the annealing treatment of step S510 are optional. That is, the glass forming method may be completed without step S502 and/or the annealing treatment of step S510.

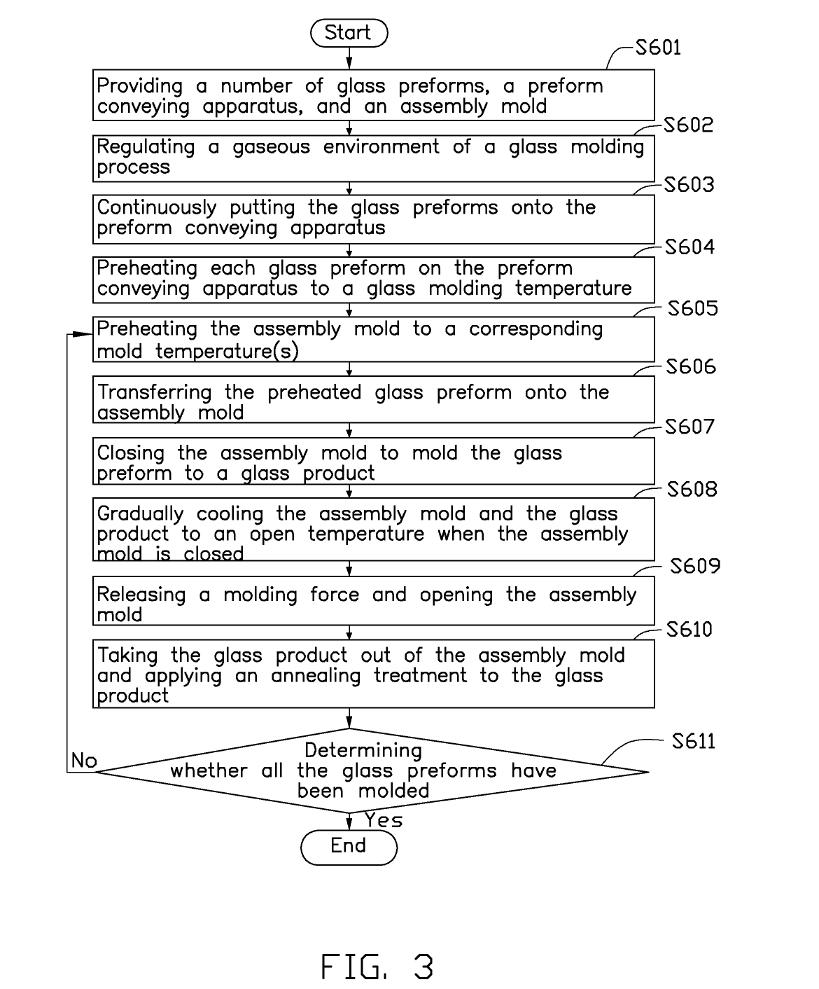

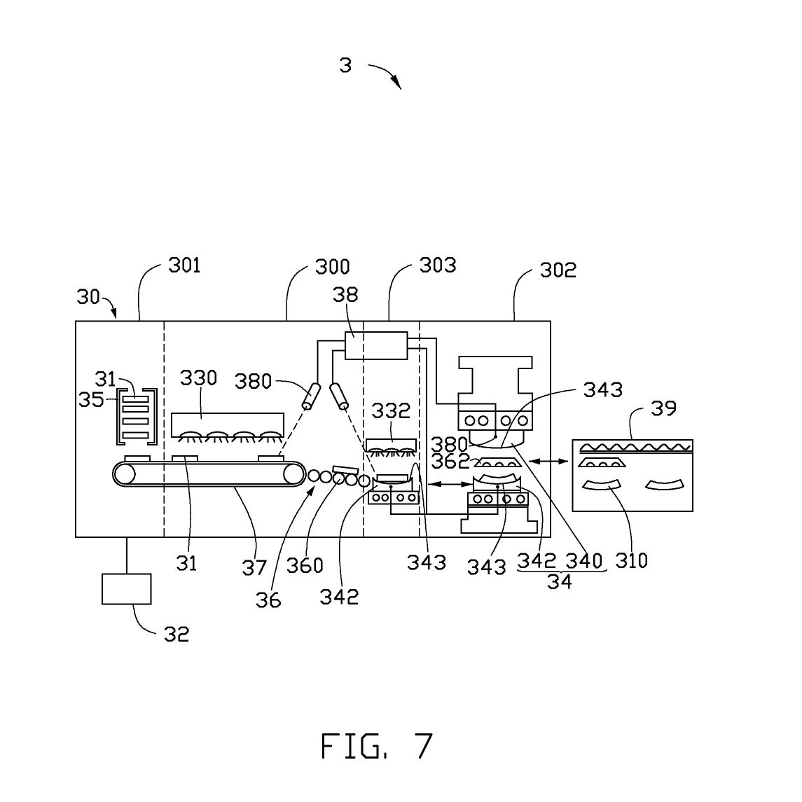

FIG. 3 is a flowchart of a third embodiment of a glass molding method, and FIG. 7 shows a corresponding glass molding device 3. Depending on the embodiment, additional steps may be added, others deleted, and the ordering of the steps may be changed. The glass molding method includes the following steps:

In step S601, a number of glass preforms 31, a preform conveying apparatus 37, and an assembly mold 34 are provided. The preform conveying apparatus 37 delivers the glass preforms 31 in order along a predetermined direction. The assembly mold 34 includes at least two sub-molds 340 and 342. In this embodiment, there is an upper sub-mold 340 and a lower sub-mold 342. Each of the sub-molds 340 and 342 includes at least one molding surface 343. When the sub-molds 340 and 342 are closed together, the molding surfaces 343 of the sub-molds 340 and 342 cooperatively define an enclosed forming space in accordance with a shape of a glass product 310.

In step S602, a gaseous environment of a glass molding process is regulated. The gaseous environment may be an atmospheric environment, an inert gas environment with a predetermined gas pressure (such as a nitrogen, helium, and/or neon inert gas environment), or a vacuum environment. The glass molding process is executed in a molding chamber 30. The gaseous environment inside the molding chamber 30 is regulated by a gas regulating apparatus 32.

In step S603, the glass preforms 31 are continuously put onto the preform conveying apparatus 37 to form a queue of glass preforms 31 moving along the predetermined direction.

In step S604, each glass preform 31 on the preform conveying apparatus 37 is preheated to a glass molding temperature Tₚᵣₑₛₛ at which the glass preform 11 is molded. The glass molding temperature Tₚᵣₑₛₛ is higher than a glass transition temperature T_{g} of the glass preform 11. For example, the glass molding temperature Tₚᵣₑₛₛ of a soda-lime glass preform 11 is in a range of from about 600 degrees Celsius to about 800 degrees Celsius. In this embodiment, the glass molding temperature Tₚᵣₑₛₛ of the glass preform 11 is 730 degrees Celsius.

In step S605, the sub-molds 340 and 342 are heated to mold temperatures T_{mold1} and T_{mold2}, respectively, and maintained at the mold temperatures T_{mold1} and T_{mold2}. The mold temperatures T_{mold1} and T_{mold2} of the sub-molds 340 and 342 may be different from each other or the same. Each of the mold temperatures T_{mold1} and T_{mold2} of the sub-molds 340 and 342 is lower than the glass molding temperature Tₚᵣₑₛₛ of the glass preform 31. For example, when the glass preform 31 is soda-lime glass, each of the mold temperatures T_{mold1} and T_{mold2} is in a range of from about 400 degrees Celsius to about 600 degrees Celsius. In this embodiment, the mold temperatures T_{mold1} and T_{mold2} are the same, and are both 400 degrees Celsius.

In step S606, the preheated glass preform 31 is transferred to the molding surface 343 of one of the sub-molds 340 or 342. In detail, a method to transfer the preheated glass preform 31 to one of the sub-molds 340 or 342 may be moving the sub-mold 340 or 342 to a terminal of the preform conveying apparatus 37, transferring the preheated glass preform 31 onto the sub-mold 340 or 342, and then moving the sub-mold 340 or 342 back in the assembly mold 34 until the sub-mold 340 or 342 aligns with the other sub-mold 342 or 340; or transferring the preheated glass preform 31 to the sub-mold 340 or 342 by a rotating mechanism; or transferring the preheated glass preform 31 to the sub-mold 340 or 342 by a suction device or a clamp. In this embodiment, the glass preform 21 is put on the molding surface 343 of the lower sub-mold 342. The lower sub-mold 342 traverses between the assembly mold 34 and the preform conveying apparatus 37.

In step S607, the sub-molds 340 and 342 are closed together to form the glass preform 31 into the glass product 310 with a predetermined shape. When the sub-molds 340 and 342 are closed together, a molding force applied on the glass preform 31 is in a range of from about 0.1 million pascal to about 5 million pascal. In this embodiment, the molding force is 1 million pascal.

In step S608, the closed assembly mold 34 and the glass product 310 formed in the closed assembly mold 34 are gradually cooled to a predetermined open temperature Tₒₚₑₙ. The open temperature Tₒₚₑₙ may be slightly higher than an upper limit of an annealing range of the glass preform 31, or within the annealing range, or slightly lower than a lower limit of the annealing range. The annealing range is a temperature range defined between an annealing point of the glass preform 31 and a strain point of the glass preform 31. The choice of the open temperature Tₒₚₑₙ depends on a balance between a forming precision of the glass product 310 and a short cycle time. For example, to cool the glass product 310 to a lower open temperature Tₒₚₑₙ achieves a better forming precision of the glass product 310; however, the cooling process takes a longer time, and it also lengthens the time of the next preheating process. In this embodiment, the open temperature Tₒₚₑₙ is 400 degrees Celsius when the glass preform 31 is soda-lime glass.

In step S609, the molding force is released and the sub-molds 340 and 342 are separated when the assembly mold 34 and the glass product 310 are cooled to the open temperature Tₒₚₑₙ.

In step S610, the glass product 310 is taken out of the assembly mold 34. Then an annealing treatment is applied to the glass product 310 to relieve any internal stress remaining in the glass product 310.

In step S611, a determination is made as to whether all the glass preforms 31 have been molded. If all the glass preforms 31 have been molded, the glass molding process is finished. If there are still one or more glass preforms 31 needing to be molded, the process goes back to step S605.

It is understood that the ordering of step S604 and step S605 may be reversed if desired; and that steps S604 and S605 may be executed at the same time if desired.

It is understood that step S602 and the annealing treatment of step S610 are optional. That is, the glass forming method may be completed without step S602 and/or the annealing treatment of step S610.

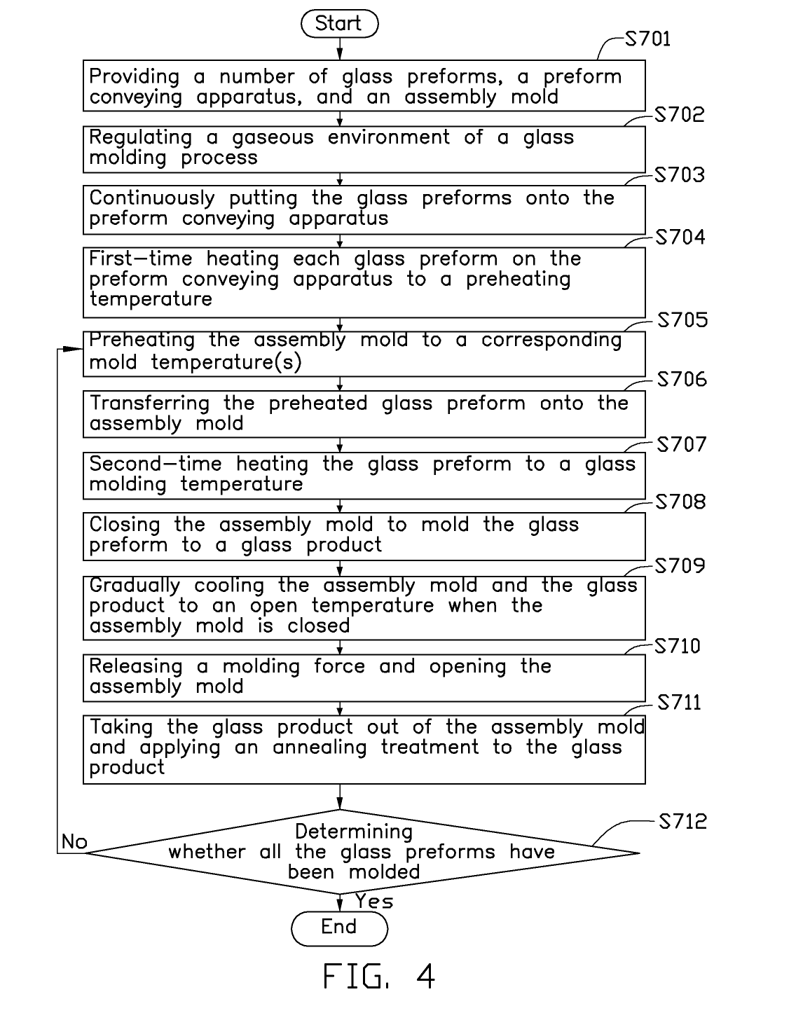

FIG. 4 is a flowchart of a fourth embodiment of a glass molding method, and FIG. 7 shows the corresponding glass molding device 3. Depending on the embodiment, additional steps may be added, others deleted, and the ordering of the steps may be changed. The glass molding method includes the following steps:

In step S701, a number of glass preforms 31, a preform conveying apparatus 37, and an assembly mold 34 are provided. The preform conveying apparatus 37 transports the glass preforms 31 in order along a predetermined direction. The assembly mold 34 includes at least two sub-molds 340 and 342. In this embodiment, there is an upper sub-mold 340 and a lower sub-mold 342. Each of the sub-molds 340 and 342 includes at least one molding surface 343. When the sub-molds 340 and 342 are closed together, the molding surfaces 343 of the sub-molds 340 and 342 cooperatively define an enclosed forming space in accordance with a shape of a glass product 310.

In step S702, a gaseous environment of a glass molding process is regulated. The gaseous environment may be an atmospheric environment, an inert gas environment with a predetermined gas pressure (such as a nitrogen, helium, and/or neon inert gas environment), or a vacuum environment. The glass molding process is executed in a molding chamber 30. The gaseous environment inside the molding chamber 30 is regulated by a gas regulating apparatus 32.

In step S703, the glass preforms 31 are continuously put onto the preform conveying apparatus 37 to form a queue of glass preforms 31 moving along the predetermined direction.

In step S704, each glass preform 31 is heated a first time on the preform conveying apparatus 37 to a preheating temperature T_{glass}. The preheating temperature T_{glass} is between a glass molding temperature Tₚᵣₑₛₛ of the glass preform 31 and a higher one of predetermined mold temperatures T_{mold1} and T_{mold2}. The choice of the preheating temperature T_{glass} also depends on a transferring method of the glass preform 31, in order to accomplish a better step-by-step heating efficiency without too much risk of deformation of the glass preform 31 when transferring the glass preform 31. For example, the preheating temperature T_{glass} should not be too high when the glass preform 31 is transferred by a clamp. If the material of the glass preform 31 is soda-lime glass, the preheating temperature T_{glass} is in a range of from about 550 degrees Celsius to about 650 degrees Celsius. In this embodiment, the preheating temperature T_{glass} is 600 degrees Celsius.

In step S705, the sub-molds 340 and 342 are heated to mold temperatures T_{mold1} and T_{mold2}, respectively, and maintained at the mold temperatures T_{mold1} and T_{mold2}. The mold temperatures T_{mold1} and T_{mold2} of the sub-molds 340 and 342 may be different from each other or the same. Each of the mold temperatures T_{mold1} and T_{mold2} of the sub-molds 340 and 342 is lower than the glass molding temperature Tₚᵣₑₛₛ of the glass preform 31. For example, when the glass preform 31 is soda-lime glass, each of the mold temperatures T_{mold1} and T_{mold2} is in a range of from about 400 degrees Celsius to about 600 degrees Celsius. In this embodiment, the mold temperatures T_{mold1} and T_{mold2} are the same, and are both 400 degrees Celsius.

In step S706, the first-time heated glass preform 31 is transferred to the molding surface 343 of one of the sub-molds 340 or 342. In detail, a method to transfer the first-time heated glass preform 31 to one of the sub-molds 340 or 342 may be moving the sub-mold 340 or 342 to a terminal of the preform conveying apparatus 37, transferring the first-time heated glass preform 31 onto the sub-mold 340 or 342, and then moving the sub-mold 340 or 342 back in the assembly mold 34 until the sub-mold 340 or 342 aligns with the other sub-mold 342 or 340; or transferring the first-time heated glass preform 31 to the sub-mold 340 or 342 by a rotating mechanism; or transferring the first-time heated glass preform 31 to the sub-mold 340 or 342 by a suction device or a clamp. In this embodiment, the glass preform 21 is put on the molding surface 343 of the lower sub-mold 342. The lower sub-mold 342 traverses between the assembly mold 34 and the preform conveying apparatus 37.

In step S707, the first-time heated glass preform 21 on the sub-mold 342 is heated a second time to the glass molding temperature Tₚᵣₑₛₛ. The glass molding temperature Tₚᵣₑₛₛ is higher than a glass transition temperature T_{g} of the glass preform 31. For example, the glass molding temperature Tₚᵣₑₛₛ of a soda-lime glass preform 31 is in a range of from about 600 degrees Celsius to about 800 degrees Celsius. In this embodiment, the glass molding temperature Tₚᵣₑₛₛ of the glass preform 31 is 730 degrees Celsius.

In step S708, the sub-molds 340 and 342 are closed together to form the glass preform 31 into the glass product 310 with a predetermined shape. When the sub-molds 340 and 342 are closed together, a molding force applied on the glass preform 31 is in a range of from about 0.1 million pascal to 5 million pascal. In this embodiment, the molding force is 1 million pascal.

In step S709, the closed assembly mold 34 and the glass product 310 formed in the closed assembly mold 34 are cooled to a predetermined open temperature Tₒₚₑₙ The open temperature Tₒₚₑₙ may be slightly higher than an upper limit of an annealing range of the glass preform 31, or within the annealing range, or slightly lower than a lower limit of the annealing range. The annealing range is a temperature range defined between an annealing point of the glass preform 31 and a strain point of the glass preform 31. The choice of the open temperature Tₒₚₑₙ depends on a balance between a forming precision of the glass product 310 and a short cycle time. For example, to cool the glass product 310 to a lower open temperature Tₒₚₑₙ achieves a better forming precision of the glass product 310; however, the cooling process takes a longer time, and it also lengthens the time of the next preheating process. In this embodiment, the open temperature Tₒₚₑₙ is 400 degrees Celsius when the glass preform 31 is soda-lime glass.

In step S710, the molding force is released and the sub-molds 340 and 342 are separated when the assembly mold 34 and the glass product 310 are cooled to the open temperature Tₒₚₑₙ.

In step S711, the glass product 310 is taken out of the assembly mold 34. Then an annealing treatment is applied to the glass product 310 to relieve any internal stress remaining in the glass product 310.

In step S712, a determination is made as to whether all the glass preforms 31 have been molded. If all the glass preforms 31 have been molded, the glass molding process is finished. If there are still one or more glass preforms 31 needing to be molded, the process goes back to step S705.

It is understood that the ordering of step S704 and step S705 may be reversed if desired; and that steps S704 and S705 may be executed at the same time if desired.

It is understood that step S702 and the annealing treatment of step S711 are optional. That is, the glass forming method may be completed without step S702 and/or the annealing treatment of step S711.

FIG. 5 shows the glass molding device 1 used to execute the first embodiment of the glass molding method. The glass molding device 1 forms a glass preform 11 into a glass product 110 with a predetermined shape. The glass molding device 1 includes a molding chamber 10, a gas regulating apparatus 12 to regulate a gaseous environment inside the molding chamber 10, a preform heater 13, an assembly mold 14, a mold heater 15, a preform transferring apparatus 16, a mold driver 17, a temperature controller 18, and an annealing apparatus 19. The preform heater 13 preheats the glass preform 11. The preform transferring apparatus 16 transfers the preheated glass preform 11 to the assembly mold 14.

The mold heater 15 heats the assembly mold 14 to a predetermined mold temperature T_{mold}. Detailedly, in the present embodiment, the mold heater 15 heats the sub-molds 140 and 142 to predetermined mold temperatures T_{mold1} and T_{mold2}, respectively. The mold driver 17 drives the sub-molds 140 and 142 of the assembly mold 14 to close together to form the glass preform 11 into the glass product 110. The temperature controller 18 controls the temperatures of the glass preform 11 and the assembly mold 14. The glass product 110 is moved into the annealing apparatus 19 to execute an annealing treatment.

The molding chamber 10 is a hermetical space. The gaseous environment may be an atmospheric environment, an inert gas environment with a predetermined gas pressure, or a vacuum environment. When needed, the gas regulating apparatus 12 fills the molding chamber 10 with the inert gas, such as nitrogen, helium and/or neon, and regulates the gas pressure inside the molding chamber 10. The molding chamber 10 is divided into at least a preheating area 100 and a molding area 102. The preheating area 100 is adjacent to the molding area 102. The two different areas 100, 102 may be isolated by a gate, or may communicate with each other without any barrier. The glass preform 11 is preheated in the preheating area 100 before being molded. The preheated glass preform 11 is molded in the molding area 102.

The preform heater 13 is set inside the preheating area 100 to preheat the glass preform 11 to a glass molding temperature Tₚᵣₑₛₛ at which the glass preform 11 is molded. The preform heater 13 may employ direct heating, indirect heating, or a combination of direct heating and indirect heating. For example, any one or a combination of heat conduction, heat convection, and heat radiation may be employed, which directly and/or indirectly transmit the heat to the glass preform 11. In detail, the preform heater 13 is selected from a group consisting of a hot plate directly holding the glass preform 11, a heater in the preheating area 100 heating the gas to generate heat convection, and an infrared light source irradiating the glass preform 11. For example, the preform heater 13 is selected from a group consisting of an electrical resistance heater, an induction heater, an infrared heater, a plasma heater, and a combustion heater. In this embodiment, the preform heater 13 is a hot plate. The hot plate derives its heat from an embedded heater. The glass preform 11 is preheated by being directly held on the hot plate.

The preform transferring apparatus 16 is located between the preheating area 100 and the molding area 102, or movable between the preheating area 100 and the molding area 102, to transfer the preheated glass preform 11 from the preform heater 13 to the molding area 102. The preform transferring apparatus 16 is also used to transfer the glass product 110 to the annealing apparatus 19. The preform transferring apparatus 16 is selected from a group consisting of a rotating mechanism to tilt the preform heater 13 combined with a roller transferring mechanism set between the preform heater 13 and the assembly mold 14, a swing-arm lifting mechanism to raise the glass preform 11 to deposit on the assembly mold 14, and a suction device or clamp movable between the preform heater 13 and the assembly mold 14. In this embodiment, the preform transferring apparatus 16 is a suction device movable between the preform heater 13 and the assembly mold 14.

The assembly mold 14 is set in the molding area 102 to mold the preheated glass preform 11. The assembly mold 14 includes at least two sub-molds 140 and 142. In the present embodiment, there are two sub-molds 140 and 142. Each of the sub-molds 140 and 142 includes at least one molding surface 143. When the sub-molds 140 and 142 are closed together, the molding surfaces 143 of the sub-molds 140 and 142 cooperatively define an enclosed forming space in accordance with a shape of a glass product 110. The glass preform 11 is pressed into the forming space to form the glass product 110 with the particular shape. In the present embodiment, the two sub-molds 140 and 142 are defined as an upper mold 140 and a lower mold 142, as shown in FIG. 5. The upper mold 140 is located directly above the lower mold 142. Each of the upper mold 140 and the lower mold 142 includes a single molding surface 143. The molding surface 143 of the upper mold 140 faces the molding surface 143 of the lower mold 142. The glass preform 11 is put on the molding surface 143 of the lower mold 142. The upper mold 140 and the lower mold 142 are either or both driven to move towards each other by the mold driver 17 in order to press the glass preform 11.

The mold heater 15 is set in the forming area 102 to heat the sub-molds 140 and 142 to the mold temperatures T_{mold1} and T_{mold2}, respectively, and maintain the mold temperatures T_{mold1} and T_{mold2} during the glass molding process. The mold temperatures T_{mold1} and T_{mold2} of the sub-molds 140 and 142 may be different from each other or the same. The choice of the mold temperatures T_{mold1} and T_{mold2} and the glass molding temperature Tₚᵣₑₛₛ depends on the material of the glass preform 11. The mold temperatures T_{mold1} and T_{mold2} are both lower than the glass molding temperature Tₚᵣₑₛₛ. The mold heater 15 is similar to the preform heater 13, and may employ direct heating, indirect heating, or a combination of direct heating and indirect heating. For example, any one or a combination of heat conduction, heat convection, and heat radiation may be employed, which directly and/or indirectly transmit the heat to each of the sub-molds 140 and 142. In detail, the mold heater 15 is selected from a group consisting of a pair of hot plates directly holding the sub-molds 140 and 142, a heater in the molding area 102 heating the gas to generate heat convection, and an infrared light source irradiating each of the sub-molds 140 and 142. For example, the mold heater 15 is selected from a group consisting of an electrical resistance heater, an induction heater, an infrared heater, a plasma heater, and a combustion heater. In this embodiment, the mold heater 15 is a pair of hot plates. The hot plates derive their heat from embedded heaters, respectively.

The temperature controller 18 measures the temperatures of the glass preform 11 and each of the sub-molds 140 and 142, and controls the preform heater 13 and the mold heater 15 to regulate the temperatures of the glass preform 11 and the sub-molds 140 and 142. The temperature controller 18 includes at least a number of thermal sensors 180. The thermal sensors 180 employ direct contact or indirect contact to measure the temperatures of the glass preform 11 and the sub-molds 140 and 142. The temperature controller 18 controls the preform heater 13 and the mold heater 15 according to the temperatures measured by the thermal sensors 180, and according to the predetermined temperature ranges of the glass preform 11 and the sub-molds 140 and 142. The thermal sensors 180 may be thermocouple rods or infrared thermometers. The thermal sensors 180 may be set inside the molding chamber 10 or outside the molding chamber 10. In this embodiment, the temperature controller 18 is set outside the molding chamber 10, and is connected to the preform heater 13, the mold heater 15, and each of the sub-molds 140 and 142 by a number of electrical wires.

The annealing apparatus 19 provides an annealing temperature range corresponding to the material of the glass product 110. The glass product 110 undergoes an annealing treatment with a predetermined temperature-to-time profile, specifically for the annealing temperature range, to relieve any internal stress remaining in the glass product 110. The annealing temperature range is defined between an annealing point of the glass preform 11 and a strain point of the glass preform 11. In this embodiment, the glass preform 11 is soda-lime glass. The annealing temperature range is defined between about 510 degrees Celsius and about 580 degrees Celsius.

FIG. 6 shows the glass molding device 2 used to execute the second embodiment of the glass molding method. The glass molding device 2 is similar to the glass molding device 1. A difference between the glass molding device 2 and the glass molding device 1 is that a preform heater 23 of the glass molding device 2 includes a first preform heater part 230 set in a preheating area 200 and at least one second preform heater part 232 set in a molding area 202. In the illustrated embodiment, there are two second preform heater parts 232. The second preform heater parts 232 heat for a second time the glass preform 21 on the assembly mold 24, wherein the glass preform 21 has already been preheated by the first preform heater part 230. That is, the glass preform 21 is heated a first time to a preheating temperature T_{glass} by the first preform heater part 230 in the preheating area 200. The preheating temperature T_{glass} is between a glass molding temperature Tₚᵣₑₛₛ of the glass preform 21 and a higher one of predetermined mold temperatures T_{mold1} and T_{mold2}. The choice of the preheating temperature T_{glass} also depends on a transferring method of the glass preform 21, in order to accomplish a better step-by-step heating efficiency without too much risk of deformation of the glass preform 21 when transferring the glass preform 21. For example, the preheating temperature T_{glass} should not be too high when the glass preform 21 is transferred by a clamp, to avoid the glass preform 21 becoming deformed by the force of gravity. The preheated glass preform 21 is transferred to the assembly mold 24 and second-time heated to the glass molding temperature Tₚᵣₑₛₛ by the second preform heater parts 232. The glass molding temperature Tₚᵣₑₛₛ is higher than a glass transition temperature T_{g} of the glass preform 21. Preferably, the second preform heater parts 232 includes a number of infrared light sources symmetrically arranged about and surrounding the glass preform 21 on the assembly mold 24.

FIG. 7 shows the glass molding device 3 used to execute the third embodiment and the fourth embodiment of the glass molding method. The glass molding device 3 is similar to the glass molding device 2. Differences between the glass molding device 3 and the glass molding device 2 are as follows. The glass molding device 3 further includes a preform feeding apparatus 35 and a preform conveying apparatus 37. The molding chamber 30 further includes a preform feeding area 301 and a preform delivering area 303. The preform feeding area 301 is defined at a front of the preheating area 300. The preform delivering area 303 is defined between the preheating area 300 and a molding area 302.

The preform feeding apparatus 35 is set inside the preform feeding area 301. The preform conveying apparatus 37 extends across the preform feeding area 301 and a preheating area 300. One end of the preform conveying apparatus 37 is set below the preform feeding apparatus 35 to receive, one at a time, the glass preforms 31 fed from the preform feeding apparatus 35. The preform feeding apparatus 35 stores a number of glass preforms 31, and feeds the glass preforms 31 onto the preform conveying apparatus 37 one at a time at predetermined intervals. The preform conveying apparatus 37 transports the glass preforms 31 from the preform feeding area 301 to the preheating area 300. The first preform heater part 330 is set nearby the preform conveying apparatus 37 to preheat the glass preforms 31 as they pass by. In this embodiment, the preform conveying apparatus 37 is a conveyer belt. The first preform heater part 330 is a number of infrared light sources set above the conveyer belt, to emit infrared rays onto the glass preforms 31 on the conveyer belt.

The preform transferring apparatus 36 includes a first preform transferring apparatus part 360 and a second preform transferring apparatus part 362. The first preform transferring apparatus part 360 is set between the preform conveying apparatus 37 and the preform delivering area 303. The first preform transferring apparatus part 360 transfers the preheated glass preform 31 to one of the sub-molds 340 or 342 of the assembly mold 34. The second preform transferring apparatus part 362 traverses between the assembly mold 34 and the annealing apparatus 39, to transfer the glass product 310 from the assembly mold 34 to the annealing apparatus 39. In this embodiment, the first preform transferring apparatus part 360 is a roller transferring mechanism set at an end of the preform conveying apparatus 37. The second transferring apparatus 362 is a suction device to pick up the molded glass product 310 and transfer the glass product 310 to the annealing apparatus 39.

In the present embodiment, each of the at least one sub-mold 342 of the assembly mold 34 is movable; and further there is only a single such sub-mold 342. The movable sub-mold 342 traverses between the preform delivering area 303 and the molding area 302, to take each glass preform 31 preheated by the first preform heater part 330 to the molding area 302. The glass preform 31 is put on the molding surface 343 of the movable sub-mold 342. The molding surface 343 of the movable sub-mold 342 aligns with the molding surface 343 of the other sub-mold 340. The movable sub-mold 342 is moved to a position adjacent to an end of the first preform transferring apparatus part 360 in the preform delivering area 303 to receive the glass preform 31. The glass preform 31 preheated by the first preform heater part 330 is transferred from the preform conveying apparatus 37 to the movable sub-mold 342 by the first preform transferring apparatus part 360. The second preform heater part 332 is set above the position where the movable sub-mold 342 stays in the preform delivering area 303, to second-time heat the preheated glass preform 31 to the glass molding temperature Tₚᵣₑₛₛ. In this embodiment, the second preform heater part 332 is a number of infrared light sources set above the movable sub-mold 342, to emit infrared rays onto the glass preform 31.

The temperature controller 38 includes at least a number of thermal sensors 380. In this embodiment, the thermal sensors 380 are two infrared thermometers and a number of thermocouple rods. The infrared thermometers face the glass preforms 31 on the preform conveying apparatus 37 and the movable sub-mold 342, to measure the first-time preheating temperature T_{glass} and the second-time glass molding temperature Tₚᵣₑₛₛ. Each thermocouple rod is set inside a respective one of the sub-molds 340 and 342, to measure the temperature of the sub-mold 340 or 342.

In summary, the glass molding method of the first embodiment and the corresponding glass molding device 1 do not require heating or cooling the assembly mold 14 and the glass preform 11 at the same time. This increases the efficiency of use of the assembly mold 14. In addition, the contact time of the heated glass preform 11 with the assembly mold 14 is reduced. This and a low operating temperature of the assembly mold 14 help diminish an interface sticking behavior between the glass preform 11 and the molding surface(s) 143 of the assembly mold 14, thus improve the surface quality of the glass product 110 and extends a service life of the assembly mold 14. Furthermore, the lower operating temperature of the assembly mold 14 can lessen stringent requirements that the material of the assembly mold 14 be of higher temperature durability. This can reduce the cost of manufacturing the assembly mold 14, and thus reduce manufacturing costs for the glass products 110. Still further, the precise control of the temperatures in the glass molding process ensures the precision of the glass product 110 obtained.

It is understood that the glass molding methods of the second, third and fourth embodiments and the corresponding glass molding devices 2 and 3 also achieve the same or similar technical effects and advantages as those described above.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments.

What is claimed is:

1. A glass molding method comprising:
providing a glass preform and an assembly mold, the assembly mold comprising at least two sub-molds;
heating the glass preform to a glass molding temperature at which the glass preform is moldable;
heating each of the sub-molds to predetermined mold temperatures and maintaining the mold temperatures;
transferring the glass preform heated to the glass molding temperature to a molding surface of one of the sub-molds heated to the mold temperature;
closing the sub-molds together to form the glass preform into a glass product with a predetermined shape;
gradually cooling the glass product and the closed assembly mold to a predetermined open temperature; and
separating the sub-molds to take the glass product out of the assembly mold.

2. The glass molding method of claim 1, wherein the glass molding temperature is higher than a glass transition temperature of the glass preform.

3. The glass molding method of claim 1, wherein each of the mold temperatures of the sub-molds is lower than the glass molding temperature.

4. The glass molding method of claim 1, wherein a molding force applied on the glass preform when the sub-molds are closed together is in a range of from about 0.1 million pascal to about 5 million pascal.

5. The glass molding method of claim 1, further comprising executing an annealing treatment to the glass product after the glass product is taken out of the assembly mold.

6. The glass molding method of claim 5, wherein an annealing temperature range of the annealing treatment is defined between an annealing point of the glass preform and a strain point of the glass preform.

7. The glass molding method of claim 6, wherein the open temperature is slightly higher than an upper limit of an annealing range of the glass preform, within the annealing range, or slightly lower than a lower limit of the annealing range.

8. The glass molding method of claim 1, wherein heating the glass preform to a glass molding temperature at which the glass preform is moldable comprises:
heating the glass preform a first time to a preheating temperature; and
heating the glass preform a second time to the glass molding temperature when the glass preform is transferred to the sub-mold.

9. The glass molding method of claim 8, wherein the preheating temperature is between the glass molding temperature of the glass preform and a higher one of the mold temperatures.

10. The glass molding method of claim 8, further comprising:
providing a preform conveying apparatus, wherein the preform conveying apparatus transports a plurality of the glass preforms in order along a predetermined direction; and
continuously feeding the glass preforms onto the preform conveying apparatus to form a queue of glass preforms moving along the predetermined direction;
wherein heating the glass preform is performed when the glass preform is on the preform transferring apparatus.

11. The glass molding method of claim 1, further comprising:
providing a preform conveying apparatus, wherein the preform conveying apparatus transports a plurality of the glass preforms in order along a predetermined direction; and
continuously feeding the glass preforms onto the preform conveying apparatus to form a queue of glass preforms moving along the predetermined direction;
wherein heating the glass preform is performed when the glass preform is on the preform transferring apparatus.

12. A glass molding device for molding a glass preform into a glass product with a predetermined shape, the glass molding device comprising:
a preform heater heating the glass preform to a glass molding temperature at which the glass preform is moldable;
an assembly mold comprising at least two sub-molds;
a mold heater heating each of the sub-molds to a predetermined mold temperature, wherein each of the mold temperatures is lower than the glass molding temperature; and
a preform transferring apparatus transferring the glass preform heated by the preform heater to one of the sub-molds;
wherein the sub-molds are closeable together to mold the glass preform into a glass product with a predetermined shape.

13. The glass molding device of claim 12, wherein the glass molding temperature is higher than a glass transition temperature of the glass preform.

14. The glass molding device of claim 12, wherein the mold temperature of each sub-mold is the same as the mold temperature of each other sub-mold.

15. The glass molding device of claim 12, wherein the mold temperatures of the sub-molds are different from each other.

16. The glass molding device of claim 12, wherein each of the preform heater and the mold heater employs at least one of direct heating and indirect heating.

17. The glass molding device of claim 16, wherein the heating is selected from the group consisting of heat conduction, heat convection and heat radiation.

18. The glass molding device of claim 16, wherein each of the preform heater and the mold heater is selected from the group consisting of an electrical resistance heater, an induction heater, an infrared heater, a plasma heater and a combustion heater.

19. The glass molding device of claim 12, further comprising an annealing apparatus for executing an annealing treatment to the glass product.

20. The glass molding device of claim 12, further comprising a temperature controller for controlling the preform heater and the mold heater, wherein the temperature controller comprises a plurality of thermal sensors to measure the temperatures of the glass preform and the sub-molds, and the temperature controller controls the preform heater and the mold heater according to the temperatures measured by the thermal sensors and the predetermined temperature ranges of the glass preform and the sub-molds.

21. The glass molding device of claim 20, wherein the thermal sensors are selected from the group consisting of a thermocouple rod and an infrared thermometer.

22. The glass molding device of claim 12, further comprising a molding chamber comprising a preheating area and a molding area adjacent to the preheating area, wherein the preform heater is set in the preheating area to heat the glass preform to the glass molding temperature, and the mold heater is set in the molding area to heat each of the sub-molds to the corresponding mold temperature.

23. The glass molding device of claim 22, further comprising a preform feeding apparatus for storing a plurality of the glass preforms and a preform conveying apparatus; wherein the molding chamber further comprises a preform feeding area in front of the preheating area, the preform feeding apparatus is set in the preform feeding area to feed the glass preforms in order onto the preform conveying apparatus, the preform conveying apparatus transports the glass preforms from the preform feeding area to the preheating area, and the preform heater is set nearby the preform conveying apparatus to heat the glass preforms.

24. The glass molding device of claim 23, wherein the molding chamber further comprises a preform delivering area between the preheating area and the molding area, the sub-molds comprise a movable sub-mold, the movable sub-mold traverses between the preform delivering area and the molding area, the preform transferring apparatus is set between the preform conveying apparatus to transfer each of the glass preforms to the movable sub-mold in the preform delivering area, and the movable sub-mold takes each of the glass preforms back to molding area.

25. The glass molding device of claim 12, further comprising a molding chamber comprising a preheating area and a molding area adjacent to the preheating area, wherein the preform heater comprises a first preform heater part set in the preheating area and a second preform heater part set in the molding area, the first preform heater part heats the glass preform a first time to a preheating temperature lower than the glass molding temperature, and the second preform heater part heats the glass preform a second time to the glass molding temperature when the glass preform is on the assembly mold.

26. The glass molding device of claim 25, wherein the preheating temperature is between the glass molding temperature and a higher one of the mold temperatures.

27. The glass molding device of claim 25, further comprising a preform feeding apparatus for storing a plurality of the glass preforms and a preform conveying apparatus; wherein the molding chamber further comprises a preform feeding area in front of the preheating area, the preform feeding apparatus is set in the preform feeding area to feed the glass preforms in order onto the preform conveying apparatus, the preform conveying apparatus transports the glass preforms from the preform feeding area to the preheating area, and the preform heater is set nearby the preform conveying apparatus to heat the glass preforms.

28. The glass molding device of claim 27, wherein the molding chamber further comprises a preform delivering area between the preheating area and the molding area, the sub-molds comprise a movable sub-mold, the movable sub-mold traverses between the preform delivering area and the molding area, the preform transferring apparatus is set between the preform conveying apparatus to transfer each of the glass preforms to the movable sub-mold in the preform delivering area, and the movable sub-mold takes each of the glass preforms back to molding area.
